(19) United States
(12) Patent Application Publication
(10) Pub. No.: US 2013/0256286 A1
(43) Pub. Date: Oct. 3, 2013

(54) LASER PROCESSING USING AN ASTIGMATIC ELONGATED BEAM SPOT AND USING ULTRASHORT PULSES AND/OR LONGER WAVELENGTHS

(71) Applicant: IPG Microsystems LLC, Manchester, NH (US)

(72) Inventors: Jeffrey P. Sercel, Hollis, NH (US); Marco Mendes, Manchester, NH (US)

(73) Assignee: IPG Microsystems LLC, Manchester, NH (US)

(21) Appl. No.: 13/905,352

(22) Filed: May 30, 2013

Related U.S. Application Data
(63) Continuation-in-part of application No. 13/422,190, filed on Mar. 16, 2012.
Application No. 13/422,190 is a continuation-in-part of application No. 12/962,050, filed on Dec. 7, 2010.
(60) Provisional application No. 61/267,190, filed on Dec. 7, 2009.

(51) Int. Cl. B23K 26/00

(52) U.S. Cl. CPC B23K 26/0066
USPC 219/121.72

(57) ABSTRACT

An adjustable astigmatic elongated beam spot may be formed from a laser beam having ultrashort laser pulses and/or longer wavelengths to machine substrates made of a variety of different materials. The laser beam may be generated with pulses having a pulse duration of less than 1 ns and/or having a wavelength greater than 400 nm. The laser beam is modified to produce an astigmatic beam that is collimated in a first axis and converging in a second axis. The astigmatic beam is focused to form the astigmatic elongated beam spot on a substrate, which is focused on the substrate in the first axis and defocused in the second axis. The astigmatic elongated beam spot may be adjusted in length to provide an energy density sufficient for a single ultrashort pulse to cause cold ablation of at least a portion of the substrate material.

### CROSS-REFERENCE TO RELATED APPLICATIONS

This application is a continuation-in-part of co-pending U.S. patent application Ser. No. 13/422,190, filed Mar. 16, 2012, which is a continuation-in-part of U.S. patent application Ser. No. 12/962,050 filed Dec. 7, 2010, which claims the benefit of U.S. Provisional Patent Application Ser. No. 61/267,190 filed Dec. 7, 2009, both of which are incorporated herein by reference.

### TECHNICAL FIELD

This invention relates to laser processing, and more particularly, relates to laser processing, such as scribing, using an astigmatic elongated beam spot formed from a solid-state laser producing ultrashort pulses and/or longer wavelengths in the visible or IR ranges.

### BACKGROUND INFORMATION

Lasers are commonly used to process or machine a workpiece, for example, by cutting or scribing a substrate or semiconductor wafer. In semiconductor manufacturing, for example, a laser is often used in the process of dicing a semiconductor wafer such that individual devices (or dies) manufactured from the semiconductor wafer are separated from each other. The dies on the wafer are separated by streets and the laser may be used to cut the wafer along the streets. A laser may be used to cut all the way through the wafer, or part way through the wafer with the remaining portion of the wafer separated by breaking the wafer at the point of perforation. When manufacturing light emitting diodes (LEDs), for example, the individual dies on the wafer correspond to the LEDs.

As the sizes of semiconductor devices decrease, the number of these devices that may be manufactured on a single wafer increases. Greater device density per wafer increases the yield and similarly reduces the cost of manufacturing per device. In order to increase this density, it is desirable to fabricate these devices as close together as possible. Positioning the devices more closely on the semiconductor wafer results in narrower streets between the devices. The laser beam is thus positioned precisely within the narrower streets and should scribe the wafer with minimal or no damage to the devices.

According to one technique, a laser may be focused onto a surface of the substrate or wafer to cause ablation of the material and to effect a partial cut. Laser scribing may be performed on a semiconductor wafer, for example, on the front side of the wafer with the devices formed thereon, referred to as front-side scribing (FSS), or on the back side of the wafer, referred to as back-side scribing (BSS). Existing systems and methods have used an astigmatic elongated beam spot or line beam to perform laser scribing, for example, as described in greater detail in U.S. Pat. No. 7,709,768, which is incorporated herein by reference.

Although such methods have provided advantages over other techniques for forming a line beam to scribe a workpiece, existing systems for scribing using an astigmatic elongated beam spot have been limited to certain materials, wavelengths, and pulse durations. Lasers producing ultrashort pulses and/or longer wavelengths in the visible and IR ranges have become commercially available but have presented challenges in certain laser scribing applications because of the desire to maintain high laser processing speeds and accuracy while minimizing melting and other heat damage.

### BRIEF DESCRIPTION OF THE DRAWINGS

These and other features and advantages of the present invention will be better understood by reading the following detailed description, taken together with the drawings wherein:

FIG. 1 is a schematic diagram of a beam delivery system (BDS) with astigmatic focal point optics, according to one embodiment of the present invention.

FIG. 2 is a schematic diagram of the BDS shown in FIG. 1 illustrating the sequential modification of the laser beam from the laser to the target.

FIG. 3 is a cross-sectional view of a beam, illustrating the formation of two focal points separately in each principal meridian.

FIG. 4 is a cross-sectional view of a beam focusing lens in the BDS shown in FIG. 1, illustrating the ‘y component’ of the highly compressed beam passing through the beam focusing lens.

FIG. 5 is a cross-sectional view of a beam focusing lens in the BDS shown in FIG. 1, illustrating the ‘x component’ of the highly compressed beam passing through the beam focusing lens.

FIG. 6 is a cross-sectional view of the BDS shown in FIG. 1, illustrating the formation of two separated focal points in one principal meridian.

FIG. 7 is a cross-sectional view of the BDS shown in FIG. 1, illustrating the formation of two separated focal points in the other principal meridian.

FIGS. 8 and 9 are cross-sectional views of the BDS shown in FIG. 1, illustrating the flexibility of adjusting processing parameters in the BDS.

### DETAILED DESCRIPTION OF THE PREFERRED EMBODIMENTS

An adjustable astigmatic elongated beam spot may be formed from a laser beam having ultrashort laser pulses and/or longer wavelengths, consistent with embodiments described herein, to machine substrates made of a variety of different materials. The laser beam may be generated with pulses having a pulse duration of less than 1 ns and/or having a wavelength greater than 400 nm. The laser beam is modified to produce an astigmatic beam that is collimated in a first axis and converging in a second axis. The astigmatic beam is focused to form the astigmatic elongated beam spot on a substrate, which is focused on the substrate in the first axis and defocused in the second axis. The astigmatic elongated beam spot may be adjusted in length to provide an energy density sufficient for a single ultrashort pulse to cause cold ablation of at least a portion of the substrate material. Thus, the adjustable astigmatic elongated beam spot allows the energy density to be adjusted to avoid losing the benefit of using ultrashort pulses for ablation, as described in greater detail below.

As used herein, “laser machining” and “laser processing” refer to any act of using laser energy to alter a workpiece and “scribing” refers to the act of machining or processing a workpiece by scanning the laser across the workpiece. Machining or processing may include, without limitation, ablation of the material at a surface of the workpiece and/or crystal damage of the material inside the workpiece. Scribing may include a series of ablations or crystal-damaged regions and does not require a continuous line of ablation or crystal damage. As used herein, “cold ablation” refers to the ablation or removal of material caused by absorption of laser energy while also removing heat through the ejection of ablated materials.

Laser induced photonic ablation may occur when atoms of a material with a defined bandgap are excited into higher quantum states through the absorption of energy. When the energy of a single photon meets or exceeds the bandgap of the target material (quantum absorption energy), laser energy can be absorbed, the exposed material is vaporized, and heat and debris are carried away in the plasma in a cold ablation process. When the material bandgap exceeds the energy of a single photon (e.g., at longer wavelengths), multiphoton absorption may be required for cold ablation. Multiphoton absorption is a non-linear intensity dependent process, and thus shorter pulses provide a more efficient process. Ultrashort laser pulses with high photonic energy, in particular, may provide an advantage in achieving multiphoton absorption.

The benefits of using ultrashort laser pulses to achieve cold ablation may be eliminated, however, when the energy density (J/cm²) or the average power (W) used are too high above an optimum value. Because multiphoton absorption is not 100% efficient, a fraction of pulse energy may be converted to heat and remain in the material. Excess heat accumulation may result in melting and/or other heat damage. This heat may accumulate when excess energy is locally applied to the material, for example, by using an energy density above an optimum process and material dependent value. In one example, the energy density should be maintained below 5 J/cm² for a 10 ps pulse to avoid undesirable heat accumulation. This heat may also accumulate when ultrashort laser pulses are applied at higher repetition rates (e.g., at 100 kHz and greater). Higher repetition rates may also cause interaction of the laser pulse with the debris plume from a prior pulse, sometimes referred to as plasma shielding, which may cause material removal to be less effective. Although increased scanning speeds may be one way to dissipate heat from high-repetition-rate lasers, accuracy may be sacrificed at higher scanning speeds.

Using an astigmatic elongated beam spot, consistent with embodiments described herein, may improve laser processing speeds with lower repetition rates and lower part-movement speeds, thereby reducing localized heating because the energy is distributed over a larger area as well as overcoming the plasma-shielding problem. Adjusting the length of the astigmatic elongated beam spot, as described in greater detail below, allows optimal use of the energy density with the available power to provide minimal heat accumulation while spreading the available energy over a large area to achieve the desired throughput. Thus, using ultrashort laser pulses facilitates the multiphoton absorption needed for cold ablation with higher wavelengths and the variable astigmatic elongated beam spot enables higher processing speeds without losing the cold ablation benefits of the ultrashort pulses. The variable astigmatic elongated beam spot allows use of the full range of pulse energy available out of any laser (and particularly ultrashort pulses) because the size of the beam spot may be optimized to match the optimum process fluence.

Increasing the length of the variable astigmatic elongated beam spot also leads to increases in linear machining speeds. The linear machining speed may be determined as follows: speed (mm/s)=pulse spacing (mm/pulse)×pulse frequency (pulses/s), where pulse spacing=beam length/total shots per location. Increasing the beam length thus increases the number of shots per location for a given pulse spacing. In other words, the longer beam allows an increased overlap (i.e., to achieve a desired depth of cut), which allows for increased cutting speeds while maintaining optimum fluence.

In addition to controlling the energy density used on target by changing the beam length, the astigmatic elongated beam spot allows for generating narrower kerfs than those created by simply focusing the beam to a standard circular spot using traditional optical methods. Because diffraction limited focusing depends on wavelength, the astigmatic elongated beam spot facilitates the ability to achieve narrower kerfs at the longer wavelengths.

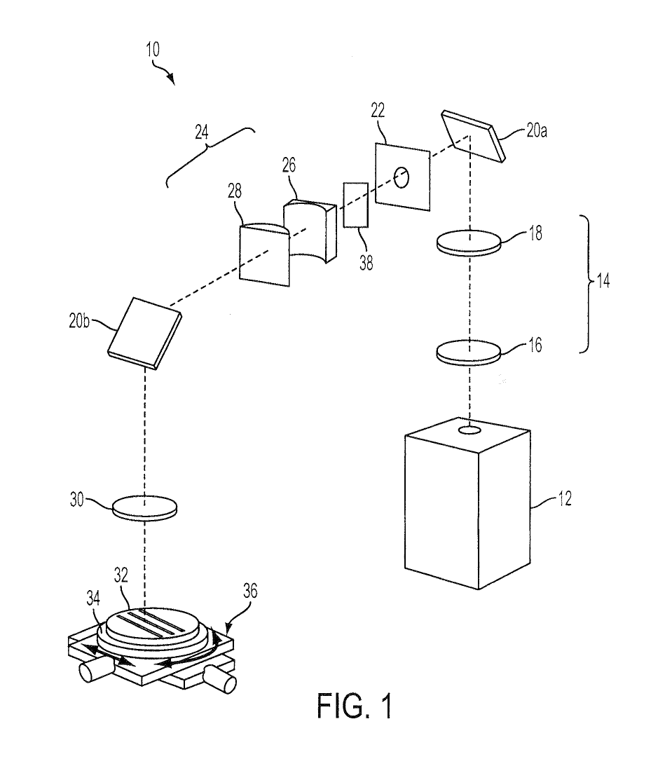

Referring to FIG. 1, one embodiment of a beam delivery system (BDS) 10 capable of generating a variable astigmatic elongated beam spot is described in detail. The variable astigmatic elongated beam spot may be used to cut or machine a substrate made of various types of materials. In one exemplary application, the BDS 10 improves the productivity of LED die separation by forming a highly-resolved adjustable astigmatic elongated beam spot, which maximizes scribing speed and minimizes consumption of scribing-related real estate on a wafer. The BDS 10 can also be used in other scribing or cutting applications.

In the embodiment shown, a solid-state laser 12, preferably diode pumped, generates a raw laser beam. The raw laser beam may be a pulsed laser beam with ultrashort pulses, i.e., a pulse duration less than 1 nanosecond (ns), providing a peak power that causes multiphoton absorption. The ultrashort pulse duration may be in any possible laser pulse duration range less than 1 ns, such as a range less than 10 picosecond (ps), a range less than 1 ps, or a range less than 1 femtosecond (fs). The laser beam may also have any possible laser wavelength including, without limitation, a wavelength in the UV range of about 100 nm to 380 nm (e.g., a 157 nm laser, a 266 nm laser, a 315 nm, or a 355 nm laser), a wavelength in the visible range of about 380 nm to 750 nm (e.g., a 515 nm or 532 nm green laser), a wavelength in the near IR range of about 0.75 μm to 1.3 μm (e.g., a 1.01 μm laser, a 1.03 μm, or a 1.07 μm laser), a wavelength in the mid IR range of 1.3 μm to 5 μm, and a wavelength in the far IR range of over 5 μm.

In some embodiments, an ultrafast laser may be capable of producing the raw laser beam at different wavelengths (e.g., about 0.35 μm, 0.5 μm, 1 μm, 1.3 μm, 1.5 μm, 2 μm or any increments therebetween) and at different ultrashort pulse durations (e.g., less than about 10 ps, 1 ps, 1 fs, or any increments therebetween). An example of an ultrafast laser includes one of the TruMicro series 5000 picosecond lasers available from TRUMPF. The laser may also provide a pulse energy in a range of about 1 μJ to 1000 μJ at repetition rates in a range of about 10 to 1000 kHz. In other embodiments, the laser may be a fiber laser such as the type available from IPG Photonics.

The raw laser beam is usually in TEM₀₀ mode with Gaussian distribution and is enlarged by a beam-expanding telescope (BET) 14. The exemplary embodiment of the BET 14 is composed of the spherical plano-concave lens 16 and spherical plano-convex lens 18. Magnification of the BET 14 is determined by the focal lengths of each lens, generally described by M=(|fₛₓ|/|fₛᵥ|), where M is magnification, fₛₓ is a focal length of the spherical plano-convex lens 18 and fₛᵥ is a focal length of the spherical plano-concave lens 16. To effect collimated beam expansion, the distance between the spherical plano-concave lens 16 and the spherical plano-convex lens 18 is determined by a general equation, D_{c}=fₛₓ+fₛᵥ, where D_{c} is a collimation distance. Combinations of fₛₓ and fₛᵥ can be used to satisfy designed values of the magnification M and the collimation distance D_{c}. The range of M can be about 2× to 20×, and is preferably 2.5× in the exemplary BDS 10. Based on this preferred magnification of 2.5×, a combination of fₛₓ=250 mm and fₛᵥ=−100 mm with D_{c}=150 mm is preferably used in this BDS 10.

In the illustrated embodiment, the expanded beam is reflected by the 100% mirror 20a and then directed to the beam shaping iris 22. The beam shaping iris 22 symmetrically crops out the low intensity edges of the beam in a Gaussian profile, leaving a high intensity portion passing through the iris 22. The beam is then directed to the center of a variable anamorphic lens system 24.

The exemplary variable anamorphic lens system 24 is composed of a cylindrical plano-concave lens 26 and a cylindrical plano-convex lens 28. The constituents of the variable anamorphic lens system 24 preferably satisfy a condition, |f_{cx}|=|f_{cv}| where f_{cx} is a focal length of the cylindrical plano-convex lens 28 and f_{cv} is a focal length of the cylindrical plano-concave lens 26. In the variable anamorphic lens system 24, the incident beam is asymmetrically modified in one of the two principal meridians, which appears in the horizontal direction in FIG. 1. In the anamorphic lens system 24, when D<D_{c}, where D is a distance between a cylindrical plano-concave lens 26 and a cylindrical plano-convex lens 28 and D_{c} is a collimation distance, a parallel incident beam is diverging after the anamorphic lens system 24. In contrast, when D>D_{c}, a parallel incident beam is converging after the anamorphic lens system 24. In the embodiment of the anamorphic lens system 24 shown in FIG. 1, the collimation distance is D_{c}=f_{cx}+f_{cv}=0, because |f_{cx}|=f_{cv}| and f_{cx} has a positive value and f_{cv} a negative value and D≦D_{c}. Accordingly, when D>0, the collimated incident beam is converging after the anamorphic lens system 24.

The degree of convergence or combined focal length (fₐₛ) of the anamorphic system 24 is governed by the distance D, and it is generally expressed by the two lens principle: fₐₛ=f_{cx}f_{cv}/(f_{cx}+f_{cv}−D). Namely, the larger the distance D, the shorter the focal length fₐₛ. When the distance D increases, the degree of convergence increases in only one principal meridian of the collimated incident beam. One principal meridian of the incident beam loses its collimation and converges after the variable anamorphic lens system 24; however, the other principal meridian is not affected and keeps its beam collimation. Consequently, the size of the beam after the variable anamorphic lens system 24 is changed in only one principal meridian by adjusting the distance between the two lenses in the anamorphic system 24. Thus, the anamorphic BDS 10 deliberately introduces astigmatism to produce focal points separated in two principal meridians, i.e. vertical and horizontal. Although a series of anamorphic lenses in different focal lengths or convergences is preferred to provide a variable astigmatic beam spot, the variable anamorphic lens system can be replaced by a single anamorphic lens for a fixed convergence.

After the variable anamorphic lens system 24, the beam is reflected by another 100% mirror 20b, and then directed to the center of a beam focusing lens 30. The exemplary beam focusing lens 30 is an aberration corrected spherical multi-element lens having a focal length range between about +20 mm to +100 mm. In one embodiment of the BDS 10, an edge-contact doublet with +50 mm focal length is used. After the beam focusing lens 30, one of the astigmatic focal points is sharply focused on a substrate 32, such as a semiconductor wafer. In one preferred embodiment, the substrate 32 is translated by computer controlled x-y motion stages 34 for scribing. In semiconductor scribing applications where the semiconductor wafer contains square or rectangular dies, the semiconductor wafer can be rotated 90 degrees by a rotary stage 36 for scribing in both the x direction and the y direction.

The preferred combination of the BET 14 and the multi-element beam focusing lens 30 yields a highly-resolved and adjustable astigmatic focal beam spot with minimal aberration and a minimized beam waist diameter. In general, a minimum beam waist diameter (wₒ) of a Gaussian beam can be expressed by: wₒ=λf/πwᵢ where λ is a wavelength of an incident laser beam, f is a focal length of a beam focusing lens, π is the circular constant, and wᵢ is a diameter of the incident beam. In a given beam focusing lens 30, the minimum beam waist diameter (wₒ) or a size focused spot is inversely proportional to the incident beam diameter (wᵢ). In the exemplary embodiment of the present invention, the BET 14 anamorphically increases the incident beam diameter (wᵢ) which is focused by the multi-element beam focusing lens 30, resulting in a minimized beam waist diameter and yielding a highly-resolved focal beam spot. This provides a sharply focused scribing beam spot capable of providing about 5 μm or less scribing kerf width on a semiconductor wafer. Consequently, the minimized scribing kerf width significantly reduces consumption of real estate on a wafer by scribing, which allows more dies on a wafer and improves productivity.

The combination of the variable anamorphic lens system 24 and the high resolution beam focusing lens 30 results in two separate focal points in each principal meridian of the incident beam. The flexibility of changing beam convergence from the variable anamorphic lens system 24 provides an instant modification of a laser energy density on a target semiconductor wafer. Since the optimum laser energy density is determined by light absorption properties of the particular target semiconductor wafer, the variable anamorphic lens system 24 can provide an instant adaptation to the optimum processing condition determined by various types of semiconductor wafers.

Although one exemplary embodiment of the anamorphic BDS 10 is shown and described, other embodiments are contemplated and within the scope of the present invention. In particular, the anamorphic BDS 10 can use different components to create the astigmatic focal beam spot or the anamorphic BDS 10 can include additional components to provide further modification of the beam.

In one alternative embodiment, a bi-prism 38 or a set of bi-prisms can be inserted between the anamorphic lens system 24 and the BET 14. The bi-prism equally divides the expanded and collimated beam from the BET 14, then crosses the two divided beams over to produce an inversion of half Gaussian profile. When a set of bi-prisms is used, the distance between the two divided beams can be adjusted by changing the distance between the set of bi-prisms. In other words, the bi-prism 38 divides the Gaussian beam by half circles and inverts the two divided half circles. A superimposition of these two circles creates superimposition of the edges of Gaussian profiles in weak intensity. This inversion of a Gaussian profile and intensity redistribution creates a homogeneous beam profile and eliminates certain drawbacks of a Gaussian intensity profile.

In another embodiment, the BDS 10 can include an array of anamorphic lens systems 24 used to create small segments of separated astigmatic ‘beamlets’, similar to a dotted line. The astigmatic beamlets allow an effective escape of laser-induced plasma, which positively alters scribing results. The distance between the lenses in the array of anamorphic lens systems controls the length of each segment of the beamlets. The distance among the segments of the beamlets can be controlled by introducing a cylindrical plano-convex lens in front of the array of anamorphic lens systems.

In other embodiments, the BDS 10 may include a high speed galvanometer followed by a focusing element such as an f-theta lens. The galvanometer allows the astigmatic elongated beam spot to be scanned across a workpiece or substrate in one or more axes without moving the workpiece. The f-theta lens allows the scanning beam from the galvanometer to be focused onto a flat surface of the substrate or workpiece without moving the lens. Other scan lenses may also be used.

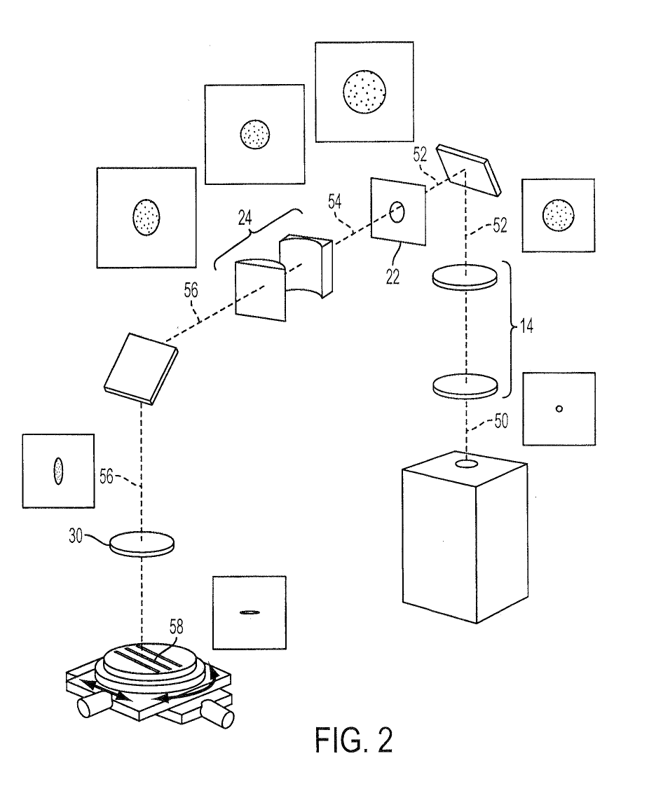

Referring to FIG. 2, one method of forming a variable astigmatic elongated beam spot is described in greater detail. The profile of raw beam 50 from the laser generally has about 0.5 mm to 3 mm of diameter in a Gaussian distribution. The raw beam 50 is expanded by the BET 14 and the expanded beam 52 is about 2.5 times larger in diameter. The expanded beam 52 is passed through the beam shaping iris 22 for edge cropping and the expanded and edge-cropped beam 54 is directed to the center of the anamorphic lens system 24. The anamorphic lens system 24 modifies the expanded and edge-cropped beam 54 in only one principle meridian, resulting in a slightly compressed beam shape 56. As the slightly compressed laser beam 56 travels towards the beam focusing lens 30, the degree of astigmatism is increased in the beam shape since the variable anamorphic lens system 24 makes the beam converge in only one principal meridian. Subsequently, the highly compressed beam 57 passes through the beam focusing lens 30 to form the astigmatic elongated beam spot 58. Since the highly compressed beam 57 has converging beam characteristics in one principal meridian and collimated beam characteristics in the other, focal points are formed separately in each principal meridian after the beam focusing lens 30. Although this method of forming the astigmatic elongated beam spot 58 is described in the context of the exemplary BDS 10, this is not a limitation on the method.

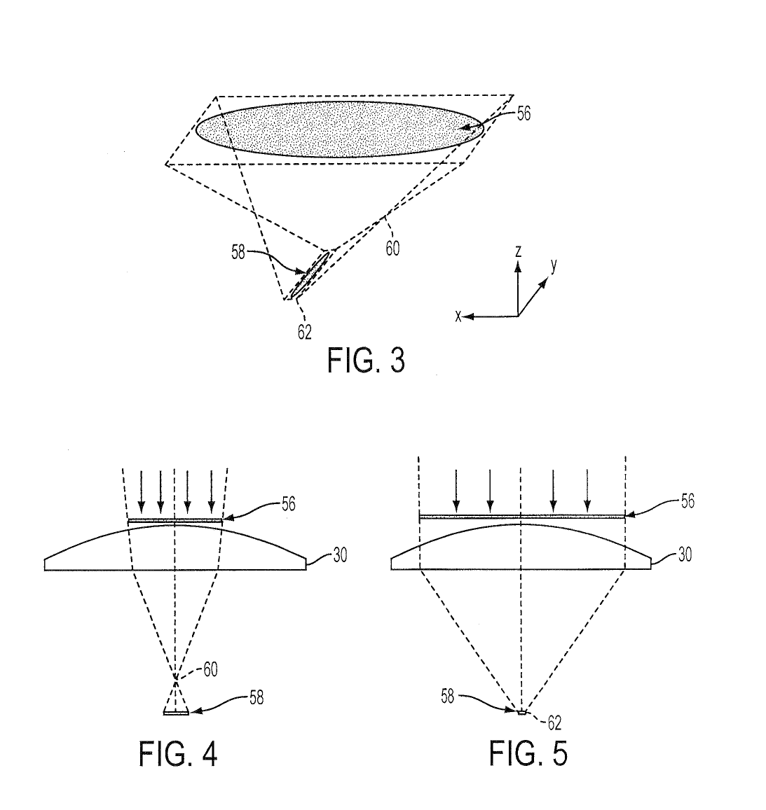

The three-dimensional diagram in FIG. 3 illustrates in greater detail the formation of the two focal points separately in each principal meridian when the highly compressed beam 57 passes through the beam focusing lens (not shown). Since the highly compressed beam 57 in one principal meridian (hereinafter the ‘y component’) has converging characteristics, the y component exhibits the short distance focal point 60. In contrast, since the other meridian (hereinafter the ‘x component’) has collimating beam characteristics, the x component exhibits the long distance focal point 62. Combination of the x and y components results in the astigmatic beam spot 58.

FIG. 4 shows the y component of the highly compressed beam 57, which passes through the beam focusing lens 30 and results in the focal point 60. After the focal point 60, the beam diverges and creates the astigmatic side of the astigmatic elongated beam spot 58.

FIG. 5 shows the x component of the highly compressed beam 57, which passes through the beam focusing lens 30 and results in the focal point 62. The collimated x component of the highly compressed beam 57 is sharply focused at the focal point 60, which creates the sharply focused side of the astigmatic elongated beam spot 58.

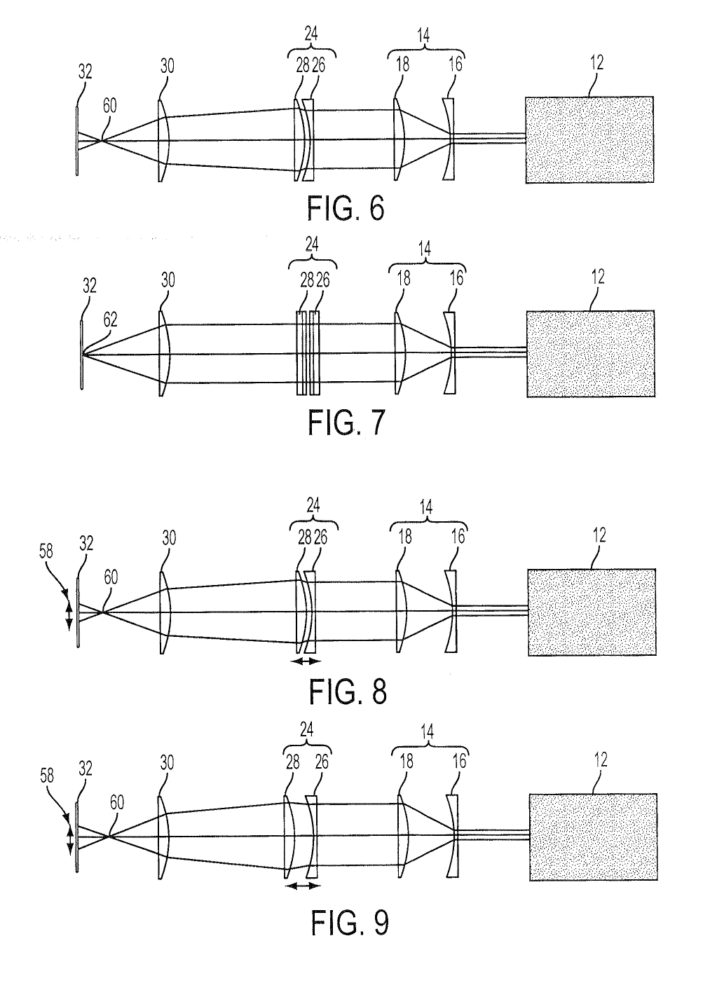

FIGS. 6 and 7 illustrate further the formation of two separated focal points 60, 62 in each principal meridian. The schematic beam tracings in FIGS. 6 and 7 include two-dimensional layouts of the BDS 10 shown in FIG. 1 excluding the 100% mirrors 20a, 20b and the beam shaping iris 22 for simplicity. In FIG. 6, the raw beam from the solid-state laser 12 is expanded by the BET 14 and then collimated. The variable anamorphic lens system 24 modifies the collimated beam in this principle meridian, resulting in convergence of the beam. The converging beam is focused by the beam focusing lens 30. Due to its convergence from the variable anamorphic lens system 24, the beam forms the focal point 60, shorter than the nominal focal length of the beam focusing lens 30. The beam tracing in FIG. 6 is analogous to the view of the y component in FIG. 4.

In contrast, in FIG. 7, the expanded and collimated beam from BET 14 is not affected by the variable anamorphic lens system 24 in this principal meridian. The collimation of the beam can be maintained in this meridian after the variable anamorphic lens system 24. After passing though the beam focusing lens 30, the collimated beam is focused at the focal point 62, which is formed at a nominal focal length of the beam focusing lens 30. The beam tracing in FIG. 7 is analogous to the view of the x component in FIG. 5. In FIG. 7, the BET 14 increases the incident beam diameter, which is focused by the multi-element beam focusing lens 30, resulting in minimized a beam waist diameter and yielding a highly-resolved elongated beam spot. As a result, the target substrate 32 (e.g., a semiconductor wafer) receives a wide and defocused astigmatic beam in one principal meridian and a narrow and sharply focused beam in the other principal meridian.

As illustrated in FIG. 3, the combination of these two separated focal points 60, 62 generates an astigmatic elongated beam spot having one side with a defocused and compressed circumference and the other side with a sharply focused and short circumference.

To scribe a substrate, the astigmatic elongated beam spot is directed at the substrate and applied with a set of parameters (e.g., wavelength, energy density, pulse repetition rate, beam size) depending upon the material being scribed. According to one method, the astigmatic elongated beam spot can be used for scribing semiconductor wafers, for example, in wafer separation or dicing applications. In this method, the wafer can be moved or translated in at least one cutting direction under the focused laser beam to create one or more laser scribing cuts. To cut dies from a semiconductor wafer, a plurality of scribing cuts can be created by moving the wafer in an x direction and then by moving the wafer in a y direction after rotating the wafer 90 degrees. When scribing in the x and y directions, the astigmatic beam spot is generally insensitive to polarization factors because the wafer is rotated to provide the cuts in the x and y directions. After the scribing cuts are made, the semiconductor wafer can be separated along the scribing cuts to form the dies using techniques known to those skilled in the art.

The astigmatic elongated beam spot provides an advantage in scribing applications by enabling faster scribing speeds. The scribing speed can be denoted by S=(l_{b}•rₚ)/n_{d}, where S is the scribing speed (mm/sec), l_{b} is the length of the focused scribing beam (mm), rₚ is pulse repetition rate (pulse/sec) and n_{d} is the number of pulses required to achieve optimum scribing cut depth. The pulse repetition rate rₚ depends on the type of laser that is used. Solid state lasers with a few pulses per second to over 10⁵ pulses per second are commercially available. The number of pulses n_{d} is a material processing parameter, which is determined by material properties of the target wafer and a desired cut depth. Given the pulse repetition rate rₚ and the number of pulses n_{d}, the beam length l_{b} is a controlling factor to determine the speed of the cut. The focused astigmatic elongated beam spot formed according to the method described above increases the beam length l_{b} resulting in higher scribing speeds.

The variable anamorphic lens system 24 also provides greater flexibility to adjust processing parameters for achieving an optimum condition. In laser material processing, for example, processing parameters should preferably be adjusted for optimum conditions based on material properties of a target. The overflow of laser energy density can result in detrimental thermal damage to the target, and the lack of laser energy density can cause improper ablation or other undesired results. In particular, the energy density of an ultrashort pulse with higher irradiance may need to be reduced to avoid losing the cold ablation benefits. As discussed in greater detail below, the variable anamorphic lens system 24 allows the energy density to be adjusted as needed depending on the pulse duration and other parameters such as laser power, wavelength, and material absorption properties.

FIGS. 8 and 9 show the flexibility of adjusting processing parameters of the BDS in this invention. In FIG. 8, the lenses 26, 28 of the variable anamorphic lens system 24 are placed close together, which results in low convergence of the collimated incident beam. This low convergence forms the focal point 60 at a relatively further distance from the beam focusing lens 30. Consequently, the length of the beam spot 58 is relatively shorter and the energy density is increased.

In contrast, in FIG. 9, the lenses 26, 28 of the variable anamorphic lens system 24 are placed further apart, which results in high convergence of the collimated incident beam. This increased convergence introduces astigmatism and forms the focal point 60 at a relatively shorter distance from the beam focusing lens 30. Consequently, the length of the beam spot 58 is relatively longer and the energy density is decreased.

In one scribing example, the astigmatic focal beam spot can be used to scribe a sapphire substrate used for blue LEDs. Optimum processing of a sapphire substrate for blue LEDs generally requires an energy density of about 10 J/cm². Since blue LED wafers are generally designed to have about a 50 μm gap among the individual die for separation, the optimum laser beam size is preferably less than about 20 μm for laser scribing. When a currently-available commercial laser with 3 Watts on target output at 50 kHz pulse repetition is used, the conventional beam focusing at a 15 μm diameter results in laser energy density of 34 J/cm². In a system with conventional beam spot focusing, the energy density on target has to be adjusted by reducing the power output of the laser for optimum processing to avoid an overflow. Thus, the laser power output cannot be fully utilized to maximize the scribing speed or productivity.

In contrast, the preferred embodiment of the BDS 10 can adjust the size of the compressed beam spot to maintain the optimum laser energy density for 10 J/cm² without reducing the power output from the laser. The size of the astigmatic elongated beam spot can be adjusted to have about 150 μm in the astigmatic axis and about 5 μm in the focused axis. Since the astigmatic axis is lined up in the scribing translation direction, this increase in beam length proportionally increases the scribing speed as discussed above. In this example, the astigmatic beam spot can provide processing speeds that are about 10 times faster than that of conventional beam focusing.

In another scribing example, the astigmatic focal beam spot can be used to scribe a sapphire substrate by coupling with one or more GaN layers on the sapphire substrate (e.g., about 4˜7 μm over the sapphire substrate) instead of coupling directly with sapphire. The lower bandgap of GaN provides more efficient coupling with the incident laser beam, requiring only about 5 J/cm² for the laser energy density. Once the laser beam couples with GaN, the ablation through the sapphire substrate is much easier than direct coupling with the sapphire. Accordingly, the size of the astigmatic elongated beam spot can be adjusted to have about 300 μm in the astigmatic axis and about 5 μm in the focused axis. Thus, the processing speed can be 20 times faster than the conventional far field imaging or spot focusing techniques.

The minimized spot size in the focused axis also significantly reduces the scribing kerf width, which subsequently reduces consumption of a wafer real estate. Furthermore, by reducing total removed material volume, the narrow scribing cuts reduce collateral material damage and ablation-generated debris. In one example, a sapphire based LED wafer may be scribed with the astigmatic focal beam spot from the BDS 10 using a 266 nm DPSS laser with on target power of about 1.8 Watt at 50 kHz. The size of the astigmatic elongated beam spot may be adjusted to have about 180 μm in the astigmatic axis and about 5 μm in the focused axis to provide a cut width of about 5 μm. Based on 30 μm deep scribing, the BDS 10 is capable of scribing speeds of greater than 50 mm/sec. The laser cut forms a sharp V-shaped groove, which facilitates well controlled fracturing after the scribing. The variable astigmatic elongated beam spot from the adjustable BDS 10 utilizes the maximum power output from the laser, which directly increases the processing speeds. Thus, front side scribing can be used to decrease the street width and increase fracture yield, thereby increasing usable die per wafer.

The astigmatic elongated beam spot can also be used advantageously to scribe other types of semiconductor wafers. The astigmatic elongated beam spot readily adjusts its laser energy density for an optimum value, based on the target material absorption properties, such as bandgap energy and surface roughness. In another example, a silicon wafer may be scribed with the astigmatic focal beam spot from the BDS 10 using a 266 nm DPSS laser with on target power of about 1.8 Watt at 50 kHz. The size of the astigmatic elongated beam spot may be adjusted to have about 170 μm in the astigmatic axis and about 5 μm in the focused axis to produce 75 μm deep scribing with a speed at about 40 mm/sec.

In a further example, a GaP wafer may be scribed using a 266 nm DPSS laser with on target power of about 1.8 Watt at 50 kHz. The size of the astigmatic elongated beam spot may be adjusted to have about 300 μm in the astigmatic axis and 5 μm in the focused axis to produce a 65 μm deep scribing with a speed at about 100 mm/sec. Similar results may be achieved in other compound semiconductor wafers such as GaAs, InP and Ge.

Other semiconductor materials such as cadmium or bismuth telluride can also be scribed/machine with high speed high quality by using an astigmatic elongated beam spot and ultrashort pulses. For example a 532 nm 10 ps laser can be used to form an astigmatic elongated beam spot 600 microns long by 20 microns wide to produce a 500 microns deep scribe with high speed (e.g., 2 meters/sec) multiple passes using 3 W average power at 200 kHz. In another example, the throughput can be roughly doubled by adjusting the beam size using a 1200 microns long beam at 6 W and 200 Khz. If higher pulse energy is available, the throughput can further be increased by correspondingly increasing the beam length, while keeping an optimum fluence.

Other substrates that can be scribed include, but are not limited to, InP, Alumina, glass, and polymers. The systems and methods described herein may also be used to scribe or process ceramic materials including, but not limited to, silicon nitride, silicon carbide, aluminum nitride, or ceramic phosphors used for light conversion in LEDs.

The astigmatic focal beam spot can also be used advantageously to scribe or machine metal films, such as molybdenum. Due to high thermal conductivity, laser cutting of metal films using conventional techniques has shown extensive heat affected zones along the wake of the laser cut. With the application of the astigmatic elongated beam spot, the 5 μm beam width in the focused axis significantly reduces a laser cutting kerf width, which subsequently reduces heat affected zones, collateral material damage and ablation-generated debris. The size of the astigmatic elongated beam spot was adjusted to have about 200 μm in the astigmatic axis and about 5 μm in the focused axis. This resulted in 50 μm deep scribing with a speed at about 20 mm/sec, using 266 nm DPSS laser with on target power of about 2.5 Watt at 25 kHz. Other types of metal can also be cut including, but not limited to, aluminum, titanium or copper. These metals may having varying thicknesses, for example, including several hundreds of microns thick down to very thin films such as those used as metallization layers for contacts on solar cells.

Although the examples show lines scribed in a substrate, the astigmatic elongated beam spot can also be used to scribe other shapes or to perform other types of machining or cutting applications. Operating parameters other than those given in the above examples are also contemplated for scribing LED wafers.

According to another scribing method, surface protection can be provided on the substrate by using a water soluble protective coating. The preferred composition of the protective coating comprises at least one surfactant in a water-soluble liquid glycerin and can be any kind of generic liquid detergent that satisfies this compositional requirement. The surfactant in the liquid glycerin forms a thin protective layer due to its high wetability. After the thin film layer is dried off, the glycerin effectively endures heat from the laser induced plasma, while preventing laser generated debris from adhering on the surface. The thin film of liquid detergent is easily removed by cleaning with pressurized water.

Accordingly, the preferred embodiment of the present invention provides advantages over conventional systems using patterned laser projection and conventional systems using far field imaging. Unlike simple far field imaging, the present invention provides greater flexibility for modifying the laser beam by using the anamorphic BDS to produce the astigmatic elongated beam spot. Unlike conventional patterned laser projection, the anamorphic BDS delivers substantially the entire beam from a laser resonator to a target, thus maintaining very high beam utilization. The formation of the astigmatic elongated beam spot also allows the laser beam to have excellent characteristics in both the optimum intensity and the beam waist diameter. In particular, the preferred embodiment of the variable anamorphic lens system enables an adjustable uniplanar compression of a laser beam, which results in a variable focal beam spot for prompt adjustments of the optimum laser intensity. By proper modification of beam spot and by maximized utilization of a raw beam, the formation of the astigmatic elongated beam spot results in numerous advantages on separation of various semiconductor wafers, including fast scribing speeds, narrow scribing kerf width, reduced laser debris, and reduced collateral damage. Moreover, the variable astigmatic elongated beam spot enables longer wavelength lasers with ultrashort pulses to be used for cold ablation with desired processing speeds and with minimal melting or heat damage.

Consistent with an embodiment, a method is provided for forming an astigmatic elongated beam spot for machining a substrate. The method includes: generating a laser beam with pulses having a pulse duration of less than 1 ns; modifying the laser beam to produce an astigmatic beam that is collimated in a first axis and converging in a second axis; and focusing the astigmatic beam to form an astigmatic elongated beam spot on a substrate, the focused astigmatic beam having a first focal point in the first axis and a second focal point in the second axis, the second focal point being separate from the first focal point such that the astigmatic elongated beam spot is focused on the substrate in the first axis and defocused in the second axis, the astigmatic elongated beam spot having a width along the first axis and a length along the second axis, the width being less than the length such that the astigmatic elongated beam spot is narrower in the first axis and wider in the second axis.

Consistent with another embodiment, the method includes: generating a laser beam having a wavelength greater than 400 nm; modifying the laser beam to produce an astigmatic beam that is collimated in a first axis and converging in a second axis; and focusing the astigmatic beam to form an astigmatic elongated beam spot on a substrate, the focused astigmatic beam having a first focal point in the first axis and a second focal point in the second axis, the second focal point being separate from the first focal point such that the astigmatic elongated beam spot is focused on the substrate in the first axis and defocused in the second axis, the astigmatic elongated beam spot having a width along the first axis and a length along the second axis, the width being less than the length such that the astigmatic elongated beam spot is narrower in the first axis and wider in the second axis.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

The invention claimed is:

1. A method of forming an astigmatic elongated beam spot for machining a substrate, the method comprising:
generating a laser beam with pulses having a pulse duration of less than 1 ns;
modifying the laser beam to produce an astigmatic beam that is collimated in a first axis and converging in a second axis; and
focusing the astigmatic beam to form an astigmatic elongated beam spot on a substrate, the focused astigmatic beam having a first focal point in the first axis and a second focal point in the second axis, the second focal point being separate from the first focal point such that the astigmatic elongated beam spot is focused on the substrate in the first axis and defocused in the second axis, the astigmatic elongated beam spot having a width along the first axis and a length along the second axis, the width being less than the length such that the astigmatic elongated beam spot is narrower in the first axis and wider in the second axis.

2. The method of claim 1 wherein the pulse duration is less than 10 ps.

3. The method of claim 1 wherein the pulse duration is less than 1 ps.

4. The method of claim 1 wherein the pulse duration is less than 1 fs.

5. The method of claim 1 wherein the laser beam has a wavelength greater than 400 nm.

6. The method of claim 1 wherein the laser beam has a wavelength in the IR range.

7. The method of claim 1 wherein the laser beam has a wavelength in the near IR range.

8. The method of claim 1 wherein the laser beam has a wavelength in the green visible range.

9. The method of claim 1 wherein the substrate includes a ceramic material.

10. The method of claim 1 wherein the substrate includes a metallic material.

11. The method of claiml wherein the substrate includes silicon.

12. The method of claim 1 wherein the substrate includes glass.

13. The method of claim 1 wherein an energy density of the astigmatic elongated beam spot is sufficient to cause cold ablation of at least a portion of the substrate with a single pulse of the laser.

14. The method of claim 13 further comprising causing the astigmatic elongated beam spot to move across the substrate in a direction of the second axis such that each successive pulse ablates at least a portion of the substrate, thereby scribing the substrate.

15. The method of claim 14 wherein causing the astigmatic elongated beam spot to move across the substrate includes moving the substrate in the direction of the second axis.

16. The method of claim 1 further comprising adjusting convergence of the laser beam in the second axis to adjust the length of the astigmatic elongated beam spot and an energy density of the astigmatic elongated beam spot on the substrate without adjusting the width of the of the astigmatic elongated beam spot.

17. The method of claim 16 wherein the energy density is adjusted such that a single pulse causes cold ablation of at least a portion of the substrate.

18. The method of claim 1 wherein modifying the laser beam includes passing the laser beam through an anamorphic lens system.

19. The method of claim 18 wherein the anamorphic lens system includes a cylindrical plano-concave lens and a cylindrical plano-convex lens.

20. The method of claim 19 further comprising:
adjusting the length of the astigmatic elongated beam spot and an energy density of the astigmatic elongated beam spot on the substrate without changing a width of the astigmatic elongated beam spot by adjusting a distance between the cylindrical plano-concave lens and the cylindrical plano-convex lens.

21. The method of claim 19 wherein the cylindrical plano-concave lens and the cylindrical plano-convex lens satisfy the condition |f_{cx}|=|f_{cv}|, where f_{cx} is a focal length of the cylindrical plano-convex lens and has a positive value and where f_{cv} is a focal length of the cylindrical plano-concave lens and has a negative value.

22. The method of claim 21 wherein a combined focal length (fₐₛ) of the anamorphic lens system changes with a distance (D) between the cylindrical plano-concave lens and the cylindrical plano-convex lens as follows: fₐₛ=f_{cx}*f_{cv}/(f_{cx}+f_{cv}−D).

23. The method of claim 1 wherein the laser beam is generated by a diode pumped solid-state (DPSS) laser.

24. The method of claiml wherein the laser beam is generated by a fiber laser.

25. The method of claim 1 further comprising expanding the laser beam and cropping edges of the expanded laser beam prior to modifying the laser beam.

26. A method of forming an astigmatic elongated beam spot for machining a substrate, the method comprising:
generating a laser beam having a wavelength greater than 400 nm;
modifying the laser beam to produce an astigmatic beam that is collimated in a first axis and converging in a second axis; and
focusing the astigmatic beam to form an astigmatic elongated beam spot on a substrate, the focused astigmatic beam having a first focal point in the first axis and a second focal point in the second axis, the second focal point being separate from the first focal point such that the astigmatic elongated beam spot is focused on the substrate in the first axis and defocused in the second axis, the astigmatic elongated beam spot having a width along the first axis and a length along the second axis, the width being less than the length such that the astigmatic elongated beam spot is narrower in the first axis and wider in the second axis.

27. The method of claim 26 wherein the laser beam has a wavelength in the IR range.

28. The method of claim 26 wherein the laser beam has a wavelength in the green visible range.

29. The method of claim 26 wherein the laser beam is generated with pulses having a pulse duration of less than 10 ps.

30. The method of claim 26 wherein focusing is performed with a fixed multi-element beam focusing lens.

31. The method of claim 26 wherein focusing is performed using a high speed galvanometer followed by a focusing element.
